(19) United States
(12) Patent Application Publication
(10) Pub. No.: US 2010/0308979 A1
(43) Pub. Date: Dec. 9, 2010

(54) SENSOR SYSTEM

(75) Inventor: Yoshimitsu Takashima, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/796,845

(22) Filed: Jun. 9, 2010

(30) Foreign Application Priority Data
Jun. 9, 2009 (JP) 2009-138438

(51) Int. Cl. G08B 9/00

(52) U.S. Cl. 340/286.02

(57) ABSTRACT

A sensor system includes a sensor unit which has a pressure sensor, a temperature sensor and a selector switching between a pressure detection signal and a temperature detection signal. The sensor system further includes a processing unit which outputs a switching command signal to the selector and receives a detection signal from the sensor unit. The switching command signal is transmitted through a communication line and the detection signal is transmitted through a signal line. The detection signal is transmitted to the processing unit in a form of an analog signal.

### CROSS-REFERENCE TO RELATED APPLICATION

This application is based on Japanese Patent Application No. 2009-138438 filed on Jun. 9, 2009, the disclosure of which is incorporated herein by reference.

### FIELD OF THE INVENTION

The present invention relates to a sensor system having a plurality of sensors which respectively detect different physical quantities. Especially, the present invention can be applied to a sensor system having a plurality of sensors mounted on a fuel injector of an internal combustion engine.

### BACKGROUND OF THE INVENTION

JP-9-113310A shows a sensor system having a sensor unit, a processing unit and a communication line. The sensor unit includes a first sensor and a second sensor. The first sensor detects a first physical quantity and outputs a first detection signal. The second sensor detects a second physical quantity and outputs a second detection signal. The processing unit receives the first and second detection signals from the sensor unit. Communication signals are transmitted between the sensor unit and the processing unit in a form of bit string through the communication line.

The sensor unit includes a selector (switching circuit) selecting a detection signal which should be outputted. This selector is operated based on a switching command signal which is transmitted from the processing unit with the communication signals. The selected detection signal is converted into a bit string by an A-D converting circuit and is transmitted to the processing unit with the communication signal.

However, in the above-mentioned conventional configuration, since the detection signal is transmitted from the sensor unit to the processing unit with the communication signal in a form of a bit string, a transmission speed of the detection signal is limited at a specified value.

### SUMMARY OF THE INVENTION

The present invention is made in view of the above matters, and it is an object of the present invention to provide a sensor system which is capable of transmitting a detection signal from a sensor unit to a processing unit at high speed.

According to the present invention, a sensor system includes: a sensor unit having a first sensor, a second sensor, and a switching sensor; a processing unit outputting a switching command signal to the sensor unit and receiving a detection signal from the sensor unit; a communication line through which the switching command signal is transmitted; and a signal line through which the detection signal is transmitted. The sensor unit transmits the detection signal detected by the first sensor or the second sensor in a form of analog signal to the processing unit through the signal line.

Since the detection signal is transmitted in a form of analog signal through the signal line, the transmission speed of the detection signal can be made high compared with the case where the detection signal is transmitted in a form of bit string through the communication line.

Moreover, since the first detection signal and the second detection signal are switchablly transmitted, both detection signals can be transmitted through one signal line. Thus, the number of the signal line can be reduced compared with the case where the separate signal lines are provided for each detection signal.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a cross-sectional view showing a sensor system in which a sensor unit is provided to a fuel injector;

FIG. 2 is a chart showing a circuit configuration of a sensor unit and a processing unit;

FIG. 3 is a block diagram showing a connecting configuration between the sensor units and the processing unit;

FIG. 4 is a time chart showing switch timings of the detection signals “SIG” with respect to each cylinder;

FIGS. 5A to 5C are time charts showing a relationship between a waveform of detection pressure and a waveform of injection rate in a case of a single-stage injection; and

FIG. 6 is a block diagram showing a connecting configuration between the sensor units and the processing unit according to another embodiment of the present invention.

### DETAILED DESCRIPTION OF EMBODIMENTS

Hereafter, an embodiment of the present invention will be described. A sensor system is applied to an internal combustion engine (diesel engine) having four cylinders #1-#4. One combustion cycle including four strokes of intake, compression, power, and exhaust is performed in sequence at a cycle of 720° CA with respect to each of four cylinders #1-#4. The combustion is performed in the cylinders #1, #3, #4, and #2 in this series with a deviation of 180° CA.

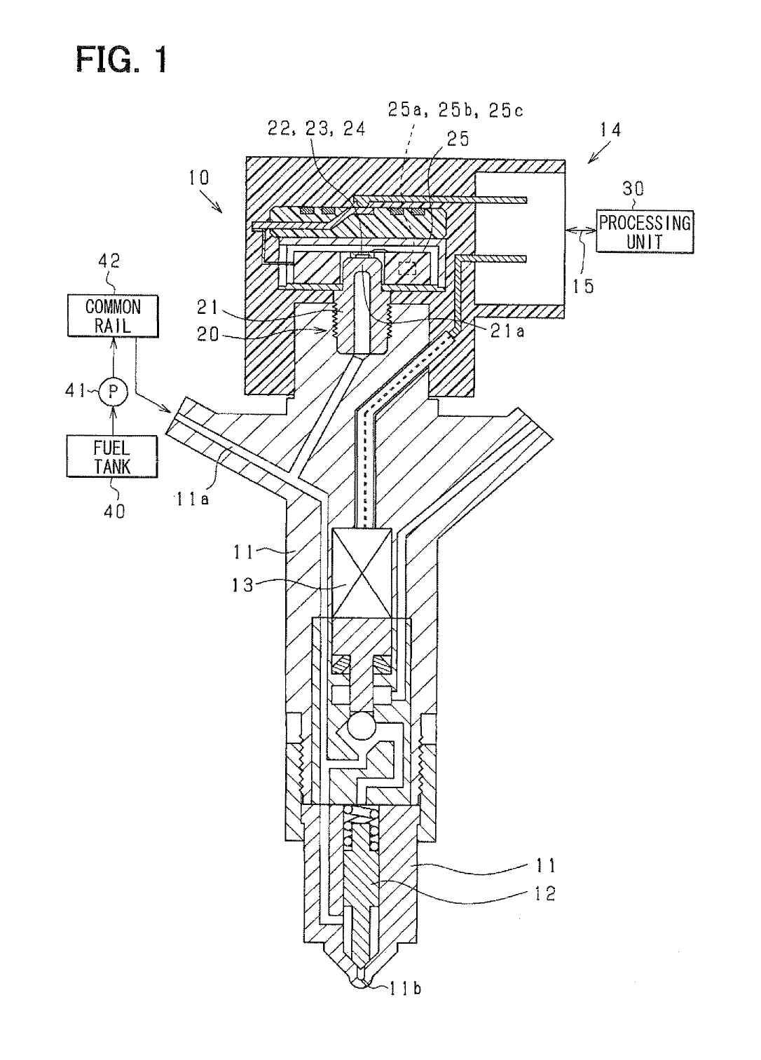

FIG. 1 is a schematic view showing a fuel injector 10, a sensor unit 20, a processing unit 30 and the like.

First, a fuel injection system of the engine including the fuel injector 10 is explained. A fuel in a fuel tank 40 is pumped up by a high-pressure pump 41 and is accumulated in a common rail 42 to be supplied to each fuel injector 10.

The fuel injector 10 is comprised of a body 11, a needle (valve body) 12, an actuator 13 and the like. The body 11 defines a high pressure passage 11a and an injection port 11b. The needle 12 is accommodated in the body 11 to open/close the injection port 11b. The actuator 13 drives the needle 12.

The processing unit 30 controls the actuator 13 to drive the needle 12. When the needle 12 opens the injection port 11b, high-pressure fuel in the high pressure passage 11a is injected to a combustion chamber (not shown) of the engine. The processing unit 30 computes a fuel injection start timing, a fuel injection end timing, a fuel injection quantity and the like based on an engine speed, an engine load and the like. The actuator 13 is driven to obtain the above computed value.

A structure of the sensor unit 20 will be described hereinafter.

The sensor unit 20 is comprised of a stem (load cell) 21, a pressure sensor (first sensor) 22, a temperature sensor (second sensor) 23, a reference sensor (third sensor) 24, and a molded IC 25. The stem 21 is connected to the body 11. The stem 21 has a diaphragm 21a which elastically deforms in response to high fuel pressure in the high pressure passage 11a. The pressure sensor 22 is disposed on the diaphragm 21a to output a pressure detection signal (first detection signal) depending on an elastic deformation of the diaphragm 21a.

Furthermore, the temperature sensor 23 and the reference sensor 24 are disposed on the stem 21. The temperature sensor 23 outputs a temperature detection signal (second detection signal) depending on a temperature of the stem 21. That is, the temperature sensor 23 outputs the temperature detection signal depending on a temperature of the pressure sensor 22. The temperature of the pressure sensor 22 is referred to as a sensor temperature.

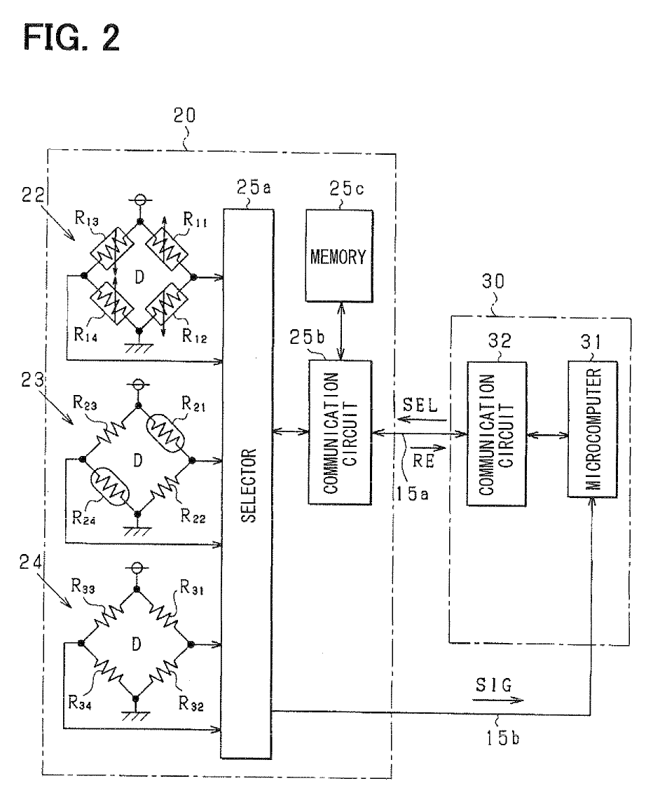

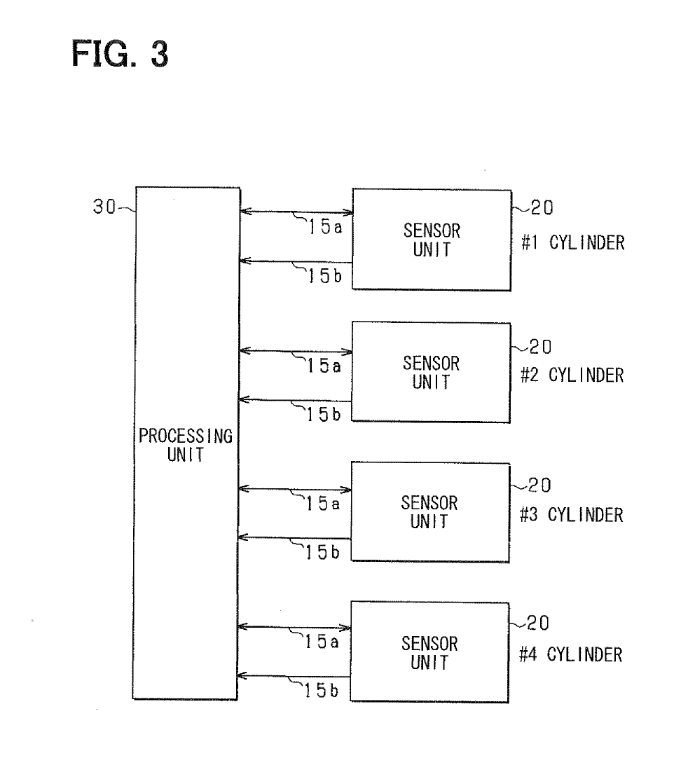

The molded IC 25 includes a selector (switching circuit) 25a, a communication circuit 25b and a memory 25c. A connector 14 is provided on the body 11. The molded IC 25 and the processing unit 39 are electrically connected to each other through a harness 15 connected to the connector 14. The harness 15 includes a power line for supplying electricity to the actuator 13, a communication line 15a and a signal line 15b which will be described hereinafter with reference to FIGS. 2 and 3.

FIG. 2 is a chart showing a circuit configuration of the sensor unit 20 and the processing unit 30.

The pressure sensor 22 is comprised of pressure-sensitive resistors R11, R12, R13, R14 of which resistance values vary according to an elastic deformation of the stem 21, that is, a fuel pressure (first physical amount) applied to the diaphragm 21a. These pressure-sensitive resistors R11-R14 forms a bridge circuit.

As the elastic deformation of the stem 21 becomes larger, a midpoint potential of the resistors R11, R12 becomes lower. As the elastic deformation of the stem becomes larger, a midpoint potential of the resistors R13, R14 becomes higher. An electric potential difference between these midpoint potentials is an output of the bridge circuit as a pressure detection signal (first detection signal). It should be noted that the pressure detection signal varies also depending on the temperature of the stem 21, which corresponds to the sensor temperature.

The temperature sensor 23 is comprised of temperature-sensitive resistors R21, R24 of which resistance values vary according to the sensor temperature (second physical amount). These temperature-sensitive resistors R21, R24 and resistors R22, R23 having no temperature characteristic forms a bridge circuit.

There is an electric potential difference between a midpoint potential of the temperature-sensitive resistor R21 and the resistor R22 and a midpoint potential of the resistor R23 and the temperature-sensitive resistor R24. This electric potential difference is an output of the bridge circuit as a temperature detection signal (second detection signal). It should be noted that the temperature detection signal depends on only the sensor memory.

The reference sensor 24 is comprised of reference resistors R31, R32, R33, R34 which have no temperature characteristic. These reference resistors R31-R34 form a bridge circuit. Originally, there is no electric potential difference between two midpoint potentials of the reference resistors R31, R32 and the reference resistors R33, R34. However, an individual difference in the sensor unit 20 may generate an electric potential difference therebetween. This electric potential difference (third physical amount) is outputted as a reference signal (third detection signal)

The selector 25a is a switching circuit which determines which signal is outputted to the processing unit 30 among the pressure detection signal, the temperature detection signal and the reference signal. This switching determination is performed based on a switching command signal “SEL” transmitted from the processing unit 30.

The processing unit 30 has a microcomputer 31 and a communication circuit 32. The microcomputer 31 includes a CPU, a memory and the like. The communication circuit 32 functions as a communication interface. The microcomputer 31 selects one of the pressure detection signal, the temperature detection signal and the reference signal. Based on this selection, the switching command signal “'SEL” is transmitted from the processing unit 30 to the sensor unit 20 through communication circuits 32, 25b. This switching command signal “SEL” is a digital signal and is transmitted in a form of a bit string through the communication line 15a.

The signal selected by the selector 25a, which is a detection signal “SIG”, is an analog signal and is transmitted to the processing unit 30 through the signal line 15b. In the processing unit 30, the detection signal “SIG” is converted into a digital signal.

At a time when the selector 25a selects the signal based on the switching command signal “SEL”, a response signal “RE” is transmitted from the sensor unit 20 to the processing unit 30. Thereby, since the microcomputer 31 can recognize a switching timing of the detection signal “SIG”, the microcomputer 31 can correctly recognize the detection signal “SIG” among the pressure detection signal, the temperature detection signal, and the reference signal,

It should be noted that the communication line 15a electrically connecting both of the communication circuits 32, 25b transmits the switching command signal “SEL” and the response signal “RE”. It is possible to perform a two-way communication through the communication line 15a. Meanwhile, the signal 15b can transmit the detection signal “SIG” in a direction from the sensor unit 20 to the processing unit 30.

FIG. 3 is a chart showing a connecting configuration of the sensor unit 20 and the processing unit 30. The sensor unit 20 is provided to each of four cylinders #1-#4. As shown in FIG. 3, four sensor units 20 are connected to one processing unit 30. The communication line 15a and the signal line 15b are connected to each sensor unit 20. Each communication line 15a and signal line 15b are respectively connected to communication ports and signal ports of the processing unit 30.

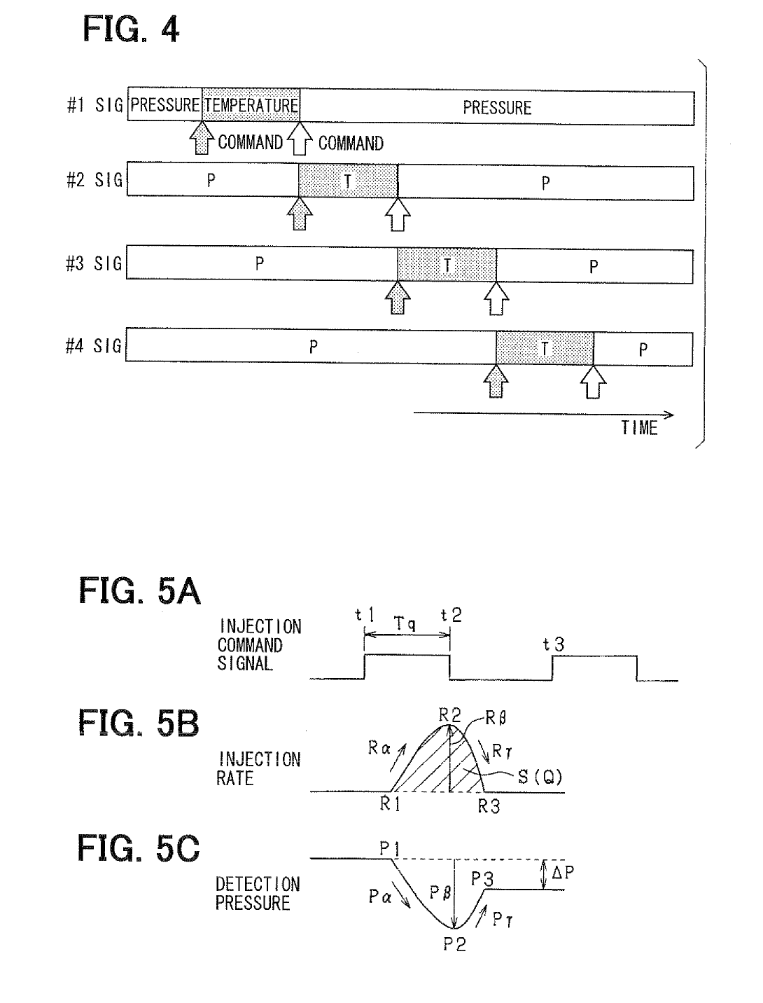

FIG. 4 is a chart showing temporal variation in the detection signal “SIG” transmitted from the sensor unit 20 of each cylinder #1-#4. Since the fuel pressure tends to change rapidly compared with the sensor temperature, a time period in which the pressure detection signal is transmitted as the detection signal “SIG” is longer than a time period in which the temperature detection signal is transmitted.

Especially, during a period in which the fuel injector 10 is injecting the fuel, the pressure detection signal is selected and transmitted to the processing unit 30 as the detection signal “SIG”. As described later with reference to FIGS. 5A to 5C, a fuel pressure variation waveform is obtained during a fuel injection period so that a variation in a fuel injection rate is estimated. Thus, during a period of fuel injection, it is prohibited that the pressure detection signal is switched to the temperature detection signal or the reference signal as the detection signal “SIG”.

As described above, the microcomputer 31 of the processing unit 30 can obtain the fuel pressure and the sensor temperature with respect to each fuel injector 10 mounted on each cylinder #1-#4.

When the detection signal “SIG” of a specified injector is other than the pressure detection signal, the pressure detection signal of the other injector is used as the pressure detection signal of the specified injector. It is preferable that the pressure detection signal of the other injector which is not injecting the fuel is used.

When the detection signal “SIG” of a specified injector is other than the temperature detection signal, the temperature detection signal of the other injector is used as the temperature detection signal of the specified injector.

Therefore, as shown in FIG. 4, it is preferable that a pressure detection signal is transmitted from at least one of cylinders #1-#4, so that all detection signals “SIG” do not become other than a pressure detection signal at the same time. Also, it is preferable that a temperature detection signal is transmitted from at least one of cylinders #1-#4, so that all detection signals “SIG” do not become other than a temperature detection signal at the same time.

As described above, the pressure detection signal varies depending on the sensor temperature as well as the fuel pressure. That is, even if actual fuel pressure is constant, the pressure detection signal varies depending on the sensor temperature. In view of this point, the microcomputer 31 corrects the obtained fuel pressure based on the obtained sensor temperature in order to perform a temperature compensation. Moreover, the obtained fuel pressure is corrected based on the reference signal obtained as the detection signal “SIG”.

The memory 25c stores the correction data for correcting characteristics variation and individual difference of the sensors 22, 23. These correction data are transmitted from the communication circuit 25b to the processing unit 30 through the communication line 15a in a form of the bit string. In addition to the temperature compensation mentioned above, the microcomputer 31 corrects the compensated fuel pressure based on the correction data.

The microcomputer 31 (fuel pressure computing means) computes a final fuel pressure by correcting the fuel pressure obtained from the pressure detection signal based on the sensor temperature, the reference signal and the correction data.

Furthermore, the microcomputer 31 (injection mode computing means) computes a fuel injection mode representing a fuel injection start timing, a fuel injection period, a fuel injection quantity and the like.

Referring to FIGS. 5A - 5C, a computation method of the injection mode will be described, hereinafter.

FIG. 5A shows injection command signals which the processing unit 30 outputs to the actuator 13. Based on this injection command signal, the actuator 13 operates to open the injection port 11b. That is, a fuel injection is started at a pulse-on timing t1 of the injection command signal, and the fuel injection is terminated at a pulse-off timing t2 of the injection command signal. During a time period Tq from the timing t1 to the timing t2, the injection port 11b is opened. By controlling the time period “Tq”, the fuel injection quantity “Q” is controlled.

FIG. 5B shows a variation in fuel injection rate and FIG. 5C shows a variation waveform in detection pressure. The detection signal “SIG” (pressure detection signal) is transmitted to the microcomputer 31 through the signal line 15b at high speed in such a manner as to obtain the variation waveform in the detection pressure. For example, during one fuel injection, the fuel pressure is detected tenth or more.

Since the variation in the detection pressure and the variation in the injection rate have a relationship described below, a waveform of the injection rate can be estimated based on a waveform of the detection pressure. That is, after the injection command signal rises at the timing t1, the fuel injection is started and the injection rate starts to increase at a timing R1. When the injection rate starts to increase at the timing R1, the detection pressure starts to decrease at a timing P1. Then, when the injection rate reaches the maximum injection rate at a timing R2, the detection pressure drop is stopped at a timing P2. When the injection rate starts to decrease at a timing R2, the detection pressure starts to increase at a timing P2. Then, when the injection rate becomes zero and the actual fuel injection is terminated at a timing R3, the increase in the detection pressure is stopped at a timing P2.

As described above, by detecting the timings P1 and P3, the injection start timing R1 and the injection terminate timing R3 can be computed. Based on a relationship between the variation in the detection pressure and the variation in the fuel injection rate, which will be described below, the variation in the fuel injection rate can be estimated from the variation in the detection pressure.

That is, a decreasing rate Pα of the detection pressure from the timing P1 to the timing P2 has a correlation with an increasing rate Rα of the injection rate from the timing R1 to the timing R2. An increasing rate Pγ of the detection pressure from the timing P2 to the timing P3 has a correlation with a decreasing rate Rγ of the injection rate from the timing R2 to the timing R3. A maximum pressure drop amount Pβ of the detected pressure has a correlation with a maximum injection rate Rβ. Therefore, the increasing rate Rα of the injection rate, the decreasing rate Rγ of the injection rate, and the maximum injection rate Rβ can be computed by detecting the decreasing rate Pα of the detection pressure, the increasing rate Pγ of the detection pressure, and the maximum pressure drop amount Pβ of the detection pressure. The variation in the injection rate (variation waveform) shown in FIG. 5B can be estimated by computing the timings R1, R3, the rates Rα, Rγ, and the maximum injection rate Rβ. Furthermore, an integral value “S” of the injection rate from the timing RI to the timing R3 (shaded area in FIG. 5B) is equivalent to the injection quantity “Q”. An integral value of the detection pressure from the timing P1 to the timing P3 has a correlation with the integral value “S” of the injection rate. Thus, the integral value “S” of the injection rate, which corresponds to the injection quantity “Q”, can be computed by computing the integral value of detection pressure.

According to the present embodiment described above, following advantages can be obtained.

(1) The switching command signal “SEL” is transmitted from the processing unit 30 to the sensor unit 20 through the communication line 15a, and the detection signal “SIG” is transmitted from the sensor unit 20 to the processing unit 30 through the signal line 15b. Since the detection signal “SIG” is transmitted in a form of analog signal through the signal line 15b, the transmission speed of the detection signal “SIG” can be made high compared with the case where the detection signal “SIG” is transmitted in a form of bit string through the communication line 15a.

(2) Since the selector 25a switches between the pressure detection signal and the temperature detection signal according to the switching command signal “SEL”, these signals can be transmitted through one signal line 15b. Thus, the number of the signal line 15b can be reduced compared with the case where the separate signal lines are provided for each detection signal.

(3) Since the processing unit 30 estimates the variation waveform of the fuel injection rate based on the detected fuel pressure in order to compute the fuel injection mode (actual fuel injection timing R1, fuel injection quantity Q and the like), it is required that the fuel pressure is detected with high resolution so that its locus can be illustrated as shown in FIG. 5C. According to the present embodiment, the detection signal “SIG” can be transmitted at high speed, so that the above requirement is satisfied.

(4) When the detection signal “SIG” of a specified injector is other than the pressure detection signal, the pressure detection signal of the other injector is used as the pressure detection signal of the specified injector. Similarly, the temperature detection signal of the other injector is used as the temperature detection signal of the specified injector.

The pressure detection signal and the temperature detection signal can be switchablly transmitted through one signal line 15b. Thus, the number of the signal line 15b can be reduced, and the fuel pressure and the sensor temperature are always obtained.

### Other Embodiment

The present invention is not limited to the embodiments described above, but may be performed, for example, in the following manner. Further, the characteristic configuration of each embodiment can be combined.

In the above embodiment, the sensor unit 20 has four communication ports to which four communication lines 15a are respectively connected.

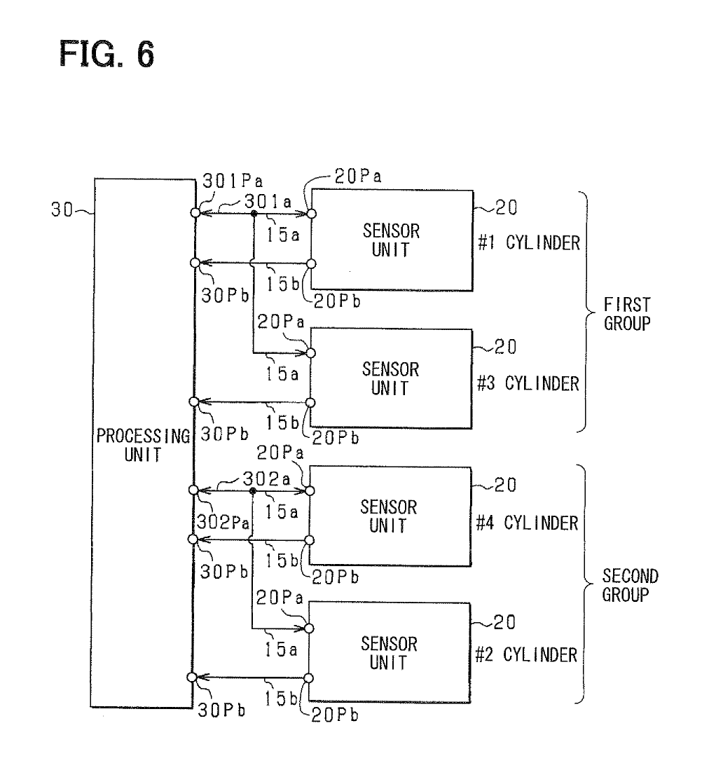

Alternatively, as shown in FIG. 6, two of communication lines 15a are connected to base lines 301a, 302a. Thus, the number of communication ports can be reduced.

Specifically, the communication line 15a is provided to each sensor unit 20, and one end of the communication line 15a is connected to a communication port 20Pa of each sensor unit 20. The other end of the communication line 15a is connected to the base line 301a or 302a. In other word, two communication lines 15a are branched from a first base line 301a connected to a first communication port 301Pa of the processing unit 30, and the other two communication lines 15a are branched from a second base line 302a connected to a second communication port 302Pa of the processing unit 30.

One end of the signal line 15b is connected to a signal port 20Pb of each sensor unit 20, and the other end of the signal line 15b is connected to a communication port 30Pb of the processing unit 30.

In the embodiment shown in FIG. 6, two base lines 301a, 302a are provided, however, all communication lines 15a may be branched from one base line.

In the configuration shown in FIG. 6, four sensor units 20 are grouped into a first group and a second group, and the same switching command signal “SEL” may be transmitted from the processing unit 30.

In the first embodiment, the switching command signal “SEL” and the response signal “RE” are transmitted through one signal line 15a by serial communication. Alternatively, two communication lines 15a are provided for each sensor unit 20, and the switching command signal “SEL” and the response signal “RE' may be transmitted through each communication line 15a by parallel communication.

In the present invention, the first sensor and the second sensor may detect physical amounts other than the fuel pressure and the sensor temperature.

What is claimed is:

1. A sensor system comprising:
a sensor unit which includes a first sensor outputting a first detection signal corresponding to a first physical amount, a second sensor outputting a second detection signal corresponding to a second physical amount, and a switching circuit switching between the first detection signal and the second detection signal;
a processing unit which outputs a switching command signal to the switching circuit and receives a detection signal from the sensor unit;
a communication line through which the switching command signal is transmitted from the processing unit to the sensor unit; and
a signal line through which the detection signal is transmitted from the sensor unit to the processing unit, wherein
the sensor unit transmits the first detection signal or the second detection signal in a form of analog signal to the processing unit through the signal line.

2. A sensor system according to claim 1, wherein
the sensor unit is provided to a fuel injector which injects a fuel into a combustion chamber of an internal combustion engine,
the first sensor detects a pressure of the fuel as the first physical amount, and
the processing unit computes a variation in the fuel pressure based on the first detection signal and computes at least one of a fuel injection start timing, a fuel injection period, and a fuel injection quantity based on the computed variation in the fuel pressure.

3. A sensor system according to claim 2, wherein
the processing unit prohibits a switching from the first detection signal to the other detection signal during a fuel injection period.

4. A sensor system according to claim 2, wherein
the internal combustion engine has a plurality of cylinders,
the fuel injector is provided to each of the cylinders,
the sensor unit is provided to each of the fuel injectors,
the processing unit is electrically connected to a plurality of sensor unit through the communication line and the signal line,
when the detection signal of the sensor unit is switched to other than the first detection signal with respect to a specified cylinder, the processing unit uses the first detection signal transmitted from the sensor unit provided to other than the specified cylinder as the first detection signal transmitted from the sensor unit provided to the specified cylinder.
